(19) United States
(12) Patent Application Publication
(10) Pub. No.: US 2026/0243163 A1
(43) Pub. Date: Aug. 20, 2026

(54) METHODS AND COMPUTING SYSTEMS FOR DETERMINING GAS STORAGE CAPACITY IN A RESERVOIR

(71) Applicant: Schlumberger Technology Corporation, Sugar Land, TX (US)

(72) Inventors: Ammar AHMAD, Crawley (GB); Klaus Eder, Vienna (AT); Iftikhar Khattak, Abu Dhabi (GB); Sergio Fabio Courtade, Lysaker (NO); Sebastian Thum, Vienna (AT)

(21) Appl. No.: 19/153,619

(22) PCT Filed: Sep. 5, 2023
(86) PCT No.: PCT/US2023/031957

§ 371 Date: Aug. 5, 2025

Related U.S. Application Data
(60) Provisional application No. 63/489,521, filed on Mar. 10, 2023.

(51) Int. Cl. E21B 49/00

(52) U.S. Cl. CPC E21B 49/00; E21B 2200/20

(57) ABSTRACT

According to an embodiment, a method for determining the gas storage capacity in a subsurface AOI comprises: receiving a stratigraphic model representing at least a portion of the AOI; receiving sensor data associated with one or more geo-parameters of the stratigraphic model; determining boundary condition data for the one or more geo-parameters based on the sensor data; imposing computational bounds on the one or more geo-parameters of the stratigraphic model using the boundary condition data thereby initializing the stratigraphic model for the AIO; executing a simulation operation on the stratigraphic model by varying one or more values of the one or more geo-parameters within limits constrained by the computational bounds imposed on the one or more geo-parameters to generate a multi-dimensional simulation dataset for the AOI; resolving the multi-dimensional simulation dataset to generate a report representing image or textual data that indicate one or more gas storage capacities of the AOI.

### CROSS-REFERENCE TO RELATED APPLICATIONS

This application claims priority to U.S. Provisional Application No. 63/489,521, filed on Mar. 10, 2023, titled “Methods And Computing Systems For Determining CO₂ Storage Capacity In A Reservoir,” which is incorporated herein by reference in its entirety for all purposes.

### TECHNICAL FIELD

The present disclosure relates to systems and methods for gas storage in a subterranean formation.

### BACKGROUND

There is a significant need to sequester gases such as CO₂, CH₄, etc., in underground storage facilities/structures created through the production of hydrocarbons over long periods of time (e.g., the last decade). For example, depleted reservoirs from which hydrocarbons have been extracted can be repurposed for storage of gases. A central question for planning such gas storage operations, however, relates to how much of said gases (e.g., CO₂, etc.) can be channeled or otherwise stored in said subterranean structures (e.g., depleted reservoir or other subsurface areas of interest). Accordingly, there is a need for methods and computing systems that can determine the gas storage capacity and monitoring mechanisms for evaluating naturally or artificially occurring subsurface structures such as depleted reservoirs for gas storage.

### SUMMARY

The computing systems, methods, processing procedures, techniques and workflows disclosed herein are more efficient and/or effective for identifying, isolating, transforming, and/or processing various aspects of seismic signals or other data that is collected from a subsurface region or other multi-dimensional spaces. The methods, according to some embodiments include: determining a gas (e.g., CO₂) storage capacity in a subsurface area of interest (“AOI”); receiving a stratigraphic model (e.g., stratigraphic forward model) representing at least a portion of the AOI; deriving a physical density for the AOI from the stratigraphic model; deriving a porosity value for the AOI from the stratigraphic model; and determining the gas (e.g., CO₂) storage capacity based at least in part on the physical density and the porosity value.

Furthermore, disclosed are methods, systems, and computer programs that determine gas storage capacity in a subsurface area of interest (“AOI”). According to an embodiment, a method for determining gas storage capacity in a subsurface AOI comprises: receiving a stratigraphic model representing at least a portion of the AOI, the stratigraphic model being calibrated using one or more geo-parameters associated with the AOI; receiving at least sensor data associated with the one or more geo-parameters of the stratigraphic model from one or more sensors deployed about the AOI; determining boundary condition data for the one or more geo-parameters of the stratigraphic model based on the sensor data; imposing computational bounds on the one or more geo-parameters of the stratigraphic model using the boundary condition data thereby initializing the stratigraphic model for the AOI; executing a simulation operation on the stratigraphic model by varying one or more values of the one or more geo-parameters within limits constrained by the computational bounds imposed on the one or more geo-parameters to generate a multi-dimensional simulation dataset for the AOI; resolving, the multi-dimensional simulation dataset to generate a report associated with the AOI, the report comprising one or more of: one or more multi-dimensional images that visually indicate one or more gas storage capacities of the AOI as a function of one or more time-steps, or textual data indicating a quantification of the one or more gas storage capacities of the one or more multi-dimensional images; and in response to selecting, based on the report, a first time-step comprised in the one or more time-steps, generating, on a graphical interface, one or more of: a first visual representation of a volume of space comprised in the AOI for storing gas at the first time-step comprised in the one or more time-steps, or a first quantifier comprised in the textual data that corresponds to a quantification of the volume of space comprised in the AOI.

These and other implementations may each optionally include one or more of the following features. The above-referenced geo-parameters of the stratigraphic model comprise one or more of: porosity data associated with the AOI; lithographic data associated with the AOI; depth of sediment deposition data associated with the AOI; sea level variation data associated with the AOI; sediment compaction data associated with the AOI; and sediment density data associated with the AOI.

Moreover, the one or more multi-dimensional images comprise one of: a plurality of 2-dimensional image data corresponding to a plurality of gas storage volumes of the AOI based on the one or more time-steps; and a plurality of 3-dimensional image data corresponding to a plurality of gas storage volumes of the AOI based on the one or more time-steps. According to some embodiments, the gas discussed in above comprises one of carbon dioxide (CO₂), methane (CH₄), nitrous oxide (N₂O), or a fluorinated gas. In addition, the AOI comprises one of a depleted oil reservoir, a depleted gas reservoir, or a depleted oil and gas reservoir.

According to some embodiments, at least one geo-parameter comprised in the one or more geo-parameters is determined based on one or more of: the sensor data associated with the one or more geo-parameters, the sensor data comprising actual data measurements by one or more surface or subsurface sensors deployed at the resource site; or synthetic data comprising one or more of: simulation data associated with simulating rock properties comprised in the AOI, and analysis data associated with extracting and analyzing or testing a geological core sample associated with the AOI. Furthermore, the one or more geo-parameters may comprise porosity data associated with the AOI such that the porosity data is determined based on one or more predictive porosity values generated based executing a plurality of simulations on the stratigraphic model over: a first period of time; or a second period of time; or a combination of the first period of time and the second period of time. Moreover, the plurality of simulations determine or predict, gas storage volume mutation data associated with the AOI and which indicates size and seal effects of a volume of space comprised in the AOI within which gas is stored over one of: the first period of time; the second period of time; or the combination of the first period of time and the second period of time. In addition, the plurality of simulations may be used to optimize the boundary condition data.

According to some embodiments, the method for determining gas storage capacity in a subsurface AOI further comprises dividing the stratigraphic model into a plurality of geological grids such that each grid comprised in the plurality of geological grids corresponds to a micro-volume associated with the AOI within which gas is stored. Additionally, the plurality of geological grids can enable resolving the AOI into a plurality of micro-volumes which, in aggregate, determine a storage dimension for the AOI. It is appreciated that the one or more gas storage capacities are based on Net/Gross volume values determined from the plurality of geological grids. It is further appreciated that the one or more gas storage capacities are based on an AOI bulk volume determined from the plurality of geological grids. Moreover, the one or more gas storage capacities are based on one or more of: a respective depth of the AOI; and a gas density of a gas stored at the respective depth. It is further appreciated that the determined gas storage capacity is based on a gas efficiency factor indicating a fraction of total pore space associated with the AOI available for storage of a gas based on one or more of: heterogeneity data associated with the gas; buoyancy effect data associated with the gas; and residual water saturation data associated with storing the gas.

In some implementations, the stratigraphic model comprises a stratigraphic forward model generated by executing a plurality of simulation operations that test distribution (e.g., geological distribution) data relative to one or more depositional physical processes acting within the AOI over time. The one or more depositional physical processes may be selected from a group consisting of diffusion, steady flow, unsteady flow, carbonate deposition through wave actions, in situ, sediment growth, and suspended sediment. The plurality of simulation operations, for example, may include simulating a plurality of rock units disposed within the AOI to determine respective physical densities of the rock units.

In some embodiments, a computing system comprising at least one processor, at least one memory, and one or more computer programs stored in the at least one memory is provided to execute the disclosed methods. In particular, the one or more computer programs comprise instructions, which when executed by the at least one processor, perform any method provided in this disclosure.

In some embodiments, a computer readable storage medium storing one or more programs is provided such that the one or more programs comprise instructions, which when executed by a processor, cause the processor to perform any method disclosed herein.

In some embodiments, a computing system comprising at least one processor, at least one memory, and one or more programs stored in the at least one memory is provided to perform any method disclosed herein.

In some embodiments, an information processing apparatus for use in a computing system is provided, and that includes means for performing any method disclosed herein.

These systems, methods, processing procedures, techniques, and workflows increase effectiveness and efficiency. Such systems, methods, processing procedures, techniques, and workflows may complement or replace conventional methods for identifying, isolating, transforming, and/or processing various aspects of seismic signals or other data that is collected from subsurface regions or other multi-dimensional spaces for the purpose of determining gas storage capacities for said subsurface regions and/or multidimensional spaces.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1A depicts an exemplary computing or network system within which the disclosed methods, systems, and computer programs can be implemented according with some embodiments of this disclosure.

FIGS. 1B-1F illustrate exemplary schematic views of a resource site for which gas storage capacities may be determined according to some embodiments of this disclosure.

FIG. 2 shows a first exemplary method for determining the gas storage capacity of an AOI for a plurality of gases.

FIG. 3 shows a second exemplary flowchart associated with methods, systems, and computer programs for determining the gas storage capacity in a subsurface AOI a resource site

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the disclosed technology. However, it will be apparent to one of ordinary skill in the art that the disclosed embodiments may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both objects or steps, respectively, but they are not to be considered the same object or step.

The terminology used in the description of the disclosed techniques is for the purpose of describing particular embodiments and is not intended to be limiting. As used in the description of this disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Computing Systems

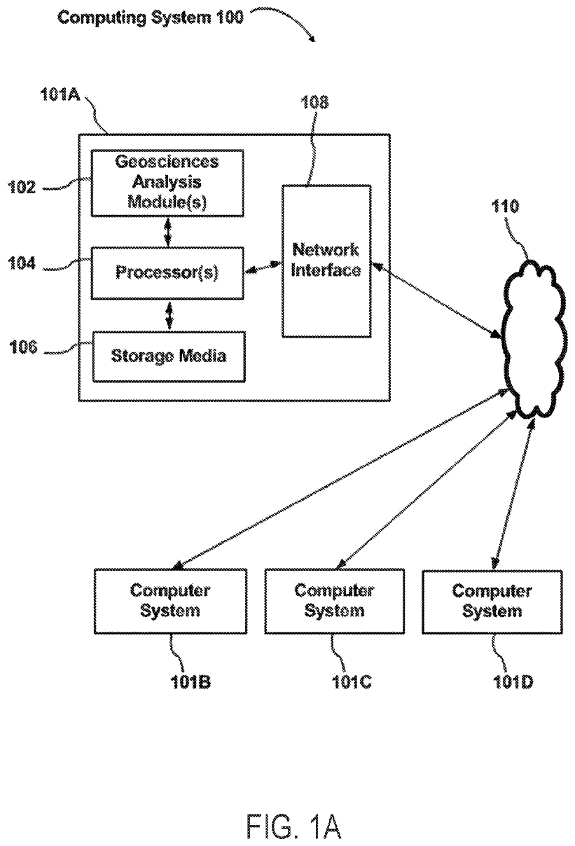

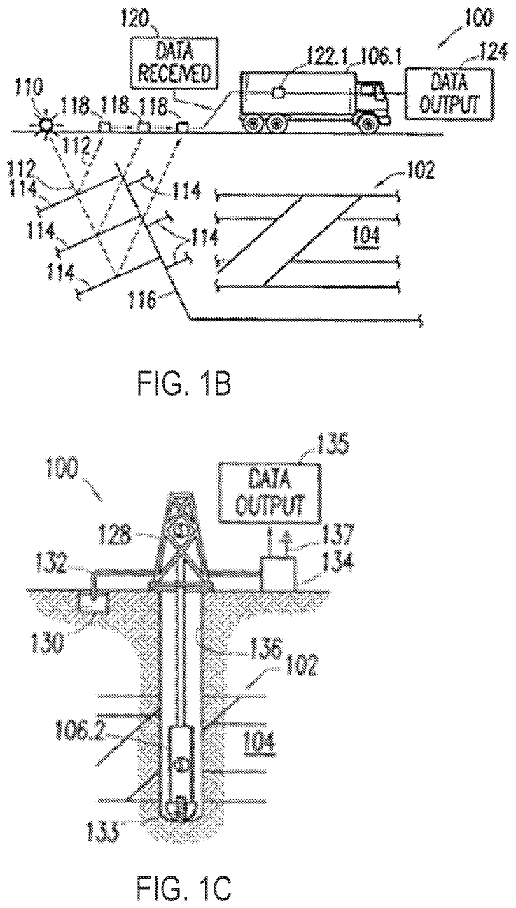

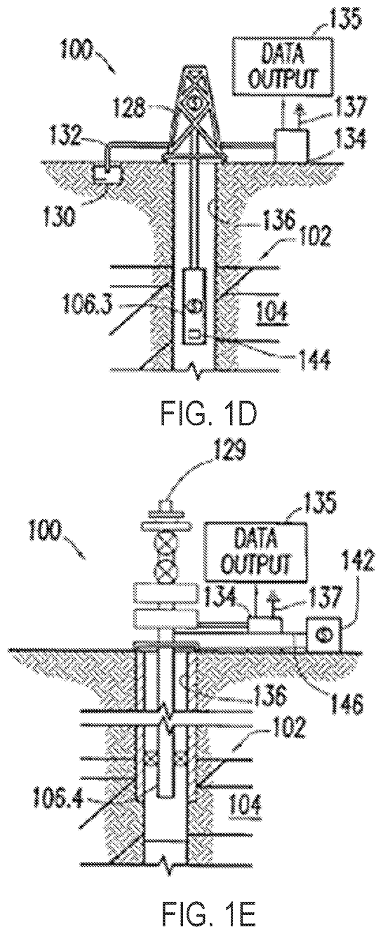

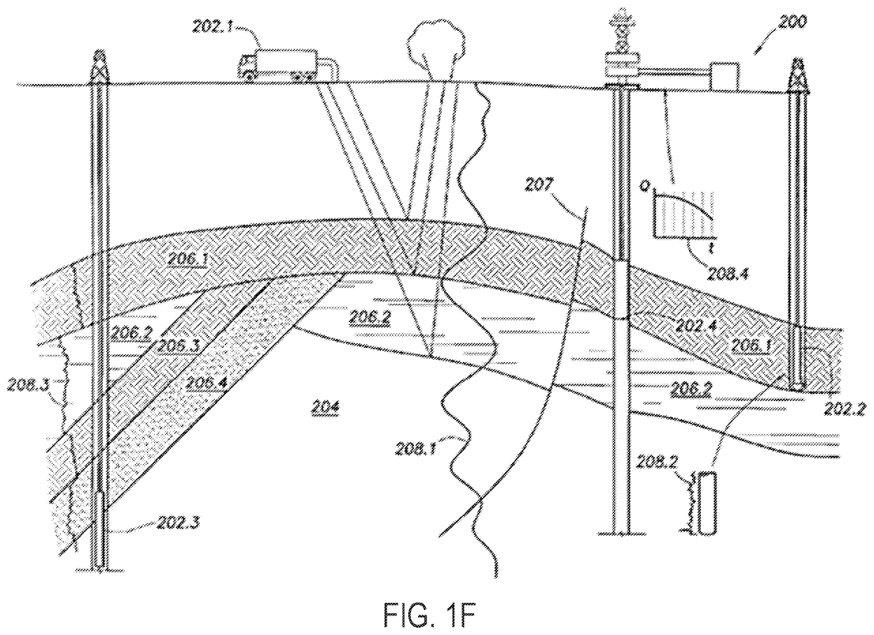

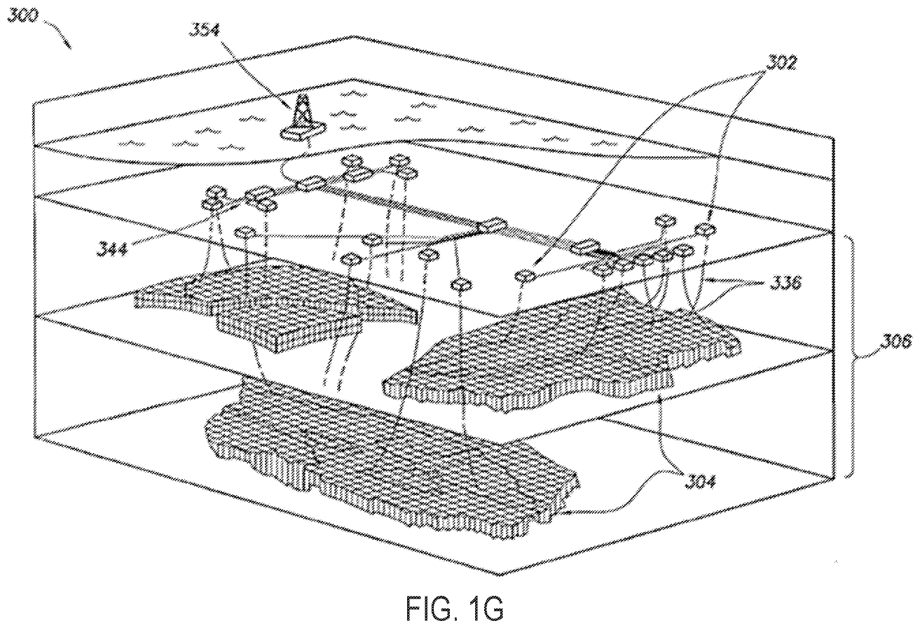

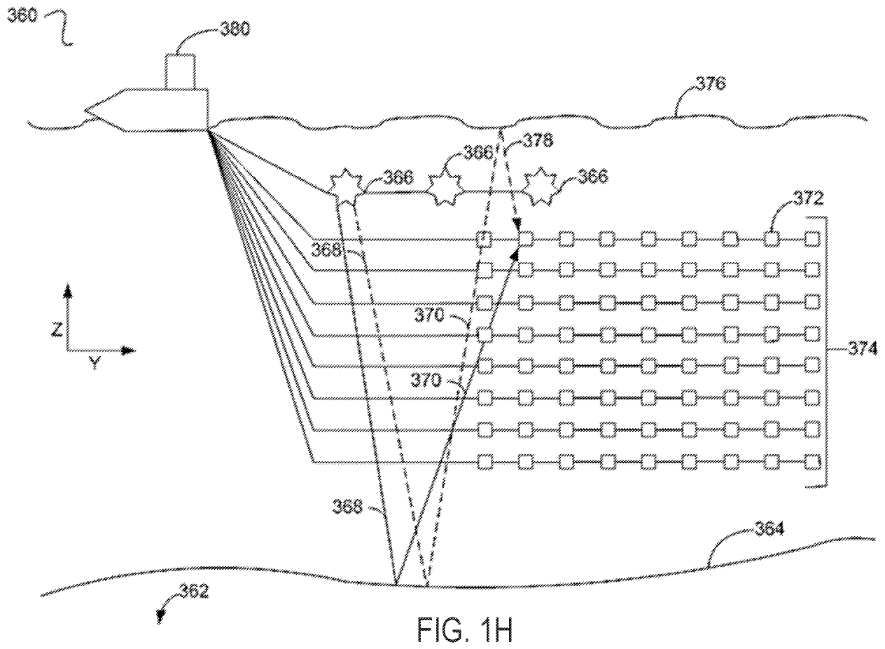

FIG. 1A depicts an example computing system 100 in accordance with some embodiments. The computing system 100 can be an individual computer system 101A or an arrangement of distributed computer systems. The computer system 101 A includes one or more geosciences analysis modules 102 that are configured to perform various tasks according to some embodiments, such as one or more methods disclosed herein. To perform these various tasks, the geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations relative to each other or to computer system 101A. For example, computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network and may use portions of public networks and may include local or remote storage and/or application processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1A storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media can be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It is appreciated that computer system 101A is one example of a computing system, and that computer system 101A may have more or fewer components than those shown and may combine additional components not depicted in the example embodiment of FIG. 1A, and/or computer system 101A may have a different configuration or arrangement of components relative to the components depicted in FIG. 1A. The various components shown in FIG. 1A may be implemented in hardware, software, or a combination of both, hardware and software, including one or more signal processing and/or application specific integrated circuits.

It is appreciated that while no user input/output peripherals are illustrated with respect to computer systems 101A, 101B, 101C, and 101D, many embodiments of computing system 100 include computer systems with keyboards, mice, touch screens, displays, and other user peripheral systems or other input-output systems. Some computer systems in use in computing system 100 may be desktop workstations, laptops, tablet computers, smartphones, server computers, etc.

Further, the steps in the processing methods described herein may be implemented by running one or more functional modules in an information processing apparatus such as general purpose processors or application specific chips, such as ASICs, FPGAs, PLDs, or other appropriate devices. These modules, combinations of these modules, and/or their combination with general hardware are included within the scope of protection of the disclosed subject-matter.

FIGS. 1B-1E illustrate exemplary schematic views of a resource site (e.g., an oilfield 100) having subterranean formation 102 containing reservoir 104 therein in accordance with implementations of various technologies and techniques described herein. FIG. 1B illustrates a survey operation being performed by a survey tool, such as seismic truck 106.1, to measure properties of the subterranean formation. The survey operation is a seismic survey operation for producing sound vibrations. In FIG. 1B, one such sound vibration, e.g., sound vibration 112 is generated by source 110 such that the sound vibration reflects off horizons 114 in the earth formation 116. A set of sound vibrations may be received by sensors (e.g., geophone-receivers 118) situated on the earth's surface. The data received 120 may be provided as input data to a computer 122.1 of a seismic truck 106.1, and responsive to the input data, computer 122.1 may generate seismic data output 124. This seismic data output may be stored, transmitted or further processed as the case may require.

FIG. 1C illustrates a drilling operation being performed by drilling tools 106.2 suspended by rig 128 and advanced into subterranean formations 102 to form wellbore 136. Mud pit 130 may be used to draw drilling mud into the drilling tools via flow line 132 to circulate drilling mud down to the drilling tools, then up the wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging systems while drilling. The logging systems may also be adapted for taking core (e.g., soil) sample 133 as shown according to some embodiments.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield 100 to collect data relating to various oilfield operations as described previously. In one embodiment, a sensor may be positioned in one or more locations around the drilling tools and/or at rig 128 to measure drilling parameters, such as weight on bit, torque on bit, pressures, temperatures, flow rates, compositions, rotary speed, and/or other parameters of the field operation. The sensors may also be positioned at one or more locations in the circulating system according to some embodiments.

Drilling tools 106.2 may include a bottom hole assembly (BHA) (not shown), near the drill bit (e.g., within several drill collar lengths from the drill bit). The bottom hole assembly may also include capabilities for measuring, processing, and storing information, as well as communicating with surface unit 134. The bottom hole assembly may further include drill collars for performing various other measurement functions.

The bottom hole assembly may include a communication subassembly that communicates with surface unit 134. The communication subassembly may be adapted to send signals to and receive signals from the surface using a communications channel such as mud pulse telemetry, electro-magnetic telemetry, wireless technology, or a wired drill pipe communications system. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other telemetry systems.

According to one embodiment, the wellbore may be drilled according to a drilling plan that is established prior to drilling. The drilling plan may set forth equipment data, pressure data, trajectory information and/or other data parameters that define or otherwise specify the drilling process for a given wellsite associated with the resource site (e.g., oilfield 100). The drilling operation may then be performed according to the drilling plan. However, as information is gathered, the drilling operation may be optimized or updated to, for example, deviate from the drilling plan to satisfy efficient drilling operations. Additionally, as drilling or other operations are performed, the subsurface conditions may change. An earth model associated with the resource site may also updated or adjusted to account for the new information being collected about the resource site.

The data gathered by the sensors disposed about the resource site may be received by surface unit 134 and/or other data collection sources for analysis or other processing. The data collected by the sensors may be used alone or in combination with other data. The data may be received by, and/or stored in one or more databases and/or transmitted to an onsite location or an offsite as the case may require. The data may be historical data, real time data, or combinations thereof. The real time data may be used in real time operations, or stored for later use. The real-time data may also be combined with historical data or other inputs for further analysis. According to one embodiment, the data collected at the resource site may be stored in separate databases, or combined within a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1D illustrates a wireline operation being performed using wireline tool 106.3 suspended by rig 128 and into wellbore 136 of FIG. 1C. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1B. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about the resource site (e.g., oilfield 100) to collect data relating to various field operations as described previously. According to one embodiment, the sensor may be positioned within wireline tool 106.3 to measure downhole parameters which relate to, for example porosity, permeability, fluid composition and/or other parameters of the field operation.

FIG. 1E illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146. According to one embodiment, sensors, such as gauges, may be positioned about oilfield 100 to collect data relating to various field operations as described previously. For example, the sensors may be positioned within production tool 106.4 or within or about an associated equipment, such as Christmas tree 129, gathering network 146, surface facility 142, and/or the production facility, to measure fluid parameters, such as fluid composition, flow rates, pressures, temperatures, and/or other parameters of the production operation. In one embodiment, one or more injection wells may be fluidly coupled to the reservoir for added fluid recovery. Furthermore, one or more gathering facilities may be operatively connected to one or more of the wellsites within the resource site (e.g., oilfield 100) for selectively collecting downhole fluids from the wellsite(s).

While FIGS. 1C-1E illustrate tools used to measure properties of a resource site (e.g., oilfield 100), it is appreciated that the tools may be used in connection with non-oilfield operations, such as gas fields, mineral mines, aquifers, storage, or other subterranean facilities. Also, while certain data acquisition tools are depicted, it is appreciated that various measurement tools capable of sensing parameters, such as seismic two-way travel time, density, resistivity, production rate, etc., of the subterranean formation and/or its geological formations may be used. Various sensors may be located at various positions along the wellbore and/or coupled to or be situated within the monitoring tools to collect and/or monitor the desired data. Other sources of data may also be provided from offsite locations to supplement or otherwise enhance data captured at the resource site.

The field configurations of FIGS. 1B-1E are intended to provide a brief description of an example of a resource site usable with oilfield application frameworks. Part of, or the entirety, of oilfield 100 may be on land, water, and/or sea. Also, while data associated with a single resource site is indicated as being measured and/or processed at a single location within these figures, oilfield applications may be used with any combination of one or more resource sites (e.g., a plurality of oilfields 100), one or more processing facilities, and one or more similar or dissimilar wellsites.

FIG. 1F illustrates a schematic view, and in particular, a partial cross section of the resource site (e.g., referenced as oilfield 200 in the figure) that has data acquisition tools 202.1, 202.2, 202.3 and 202.4 positioned at various locations about the resource site for collecting data of subterranean formation 204 in accordance with implementations of various technologies and techniques described herein. Data acquisition tools 202.1-202.4 may be the same as data acquisition tools 106.1-106.4 of FIGS. 1B-1E, respectively, or others not depicted. As shown, data acquisition tools 202.1-202.4 may generate data plots or measurements 208.1-208.4, respectively. These data plots are depicted along the resource site (e.g., oilfield 200) to demonstrate the data generated by the various operations.

Data plots 208.1-208.3 are examples of static data plots that may be generated by data acquisition tools 202.1-202.3, respectively; however, it is appreciated that data plots 208.1-208.3 may include data plots that are updated in real time or near-real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that can provide, for example, a resistivity measurement or some other measurements of the formation at various depths. Also shown in the figure is a production decline curve or graph 208.4 which indicates a dynamic data plot of the fluid flow rate over time. The production decline curve can provide the production rate as a function of time. As fluid flows through the wellbore, measurements may be taken of fluid properties, such as flow rates, pressures, composition, etc., according to some embodiments.

According to some implementations, other data may also be collected or captured or associated with the resource site, such as historical data, user input data, economic data, and/or other sensor data and/or other parametric data associated with one or more models of the resource site. As described below, static and dynamic measurements may be analyzed and/or used to generate models of the subterranean formation to determine characteristics thereof. Similar or dissimilar measurements may also be used to measure or track changes a geological formation associated with the resource over time.

In one embodiment, the subterranean structure 204 may have a plurality of geological formations 206.1-206.4. As shown in FIG. 1F, this geological formations may comprise several formations or layers, including a shale layer 206.1, a carbonate layer 206.2, a shale layer 206.3 and a sand layer 206.4. A fault 207 may extend through the shale layer 206.1 and the carbonate layer 206.2. In addition, the static data acquisition tools may be adapted to take measurements and detect characteristics of the aforementioned formations and/or other geological structures within the subterranean structure 204. While a specific subterranean formation with specific geological structures is depicted FIG. 1F, it is appreciated that the resource site (e.g., oilfield 200) may contain a variety of geological structures and/or formations, sometimes having extreme complexity than those depicted. In some locations within the subterranean structure 204 may be below the water line such that fluid may occupy pore spaces of the one or more formations depicted. Each of the measurement devices may be used to measure properties of the formations and/or other geological features within the subterranean structure 204. While each acquisition tool is shown as being in specific locations at the resource site (e.g., oilfield 200), it will be appreciated that one or more types of measurement may be taken at one or more locations across one or more fields or other locations for comparison and/or for analysis and/or for integration with data captured at the resource site. The data captured from various sources, such as the data acquisition tools of FIG. 1F, may then be processed and/or evaluated. In some embodiments, seismic data may be displayed in a static data plot 208.1 from the data acquisition tool 202. 1 and may be used to determine characteristics of the subterranean formations and other geological features associated with the resource site. The core data shown in the static plot 208.2 and/or log data from the well log 208.3 may be used to determine various characteristics of the subterranean formation. The production data from graph 208.4 may also be used to determine fluid flow reservoir characteristics as the case may require. In one embodiment, the captured data from the resource site may be used to generate models that facilitate additional analysis of the subterranean structure 204 of the resource site.

FIG. 1G illustrates a resource site (e.g., oilfield 300) for performing production operations in accordance with implementations of various technologies and techniques described herein. As shown, the resource site has a plurality of wellsites 302 operatively connected to central processing facility 354. The resource site configuration of FIG. 1G is not intended to limit the scope of the oilfield application system. Part, or all, of the resource site may be on land and/or sea. Also, while a single resource site with a single processing facility and a plurality of wellsites is depicted, any combination of one or more resource sites, one or more processing facilities 354 and one or more wellsites 302 may be present according to some embodiments.

Each wellsite 302 may have equipment associated with one or more wellbores 336 within the subterranean formation 306 of the resource site. In particular, the wellbores 336 may extend through or into the subterranean formations 306 including reservoirs 304. These reservoirs 304 may contain liquid and/or gaseous fluids, such as hydrocarbons. In one embodiment, the wellsites 302 may draw fluid to and/or from the reservoirs and may pass said fluids to processing facilities via surface networks 344. The surface networks 344 may have tubing and control mechanisms for controlling the flow of fluids from the wellsite 302 to processing facility 354.

Attention is now directed to FIG. 1H, which illustrates a side view of a marine-based survey 360 of a subterranean subsurface 362 in accordance with one or more implementations of various techniques described herein. Subsurface 362 may include seafloor surface 364. Seismic sources 366 may include marine sources such as vibroseis or airguns, which may propagate seismic waves 368 (e.g., energy signals) into the Earth over an extended period of time or at a nearly instantaneous energy level provided by impulsive or pulse sources. The seismic waves may be propagated by marine sources as a frequency sweep signal. For example, marine sources of the vibroseis type may initially emit a seismic wave at a low frequency (e.g., 5 Hz) and increase the seismic wave frequency to a high frequency (e.g., 80-90 Hz) over time. In one embodiment, the component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data. In some implementations, each streamer (e.g., comprised in the streamer array 374) may include streamer steering devices such as a bird, a deflector, a tail buoy and the like, which are not illustrated in FIG. 1H. The streamer steering devices may be used to control the position of the streamers (e.g., comprised in the streamer array 374) in accordance with the techniques described herein. In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is may be referred to as the downward reflection point.

According to some implementations, the electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Typically, marine seismic acquisition systems may tow each streamer comprised in the streamer array 374 to the same depth (e.g., 5-10 m) within a body of water (e.g., the sea). However, marine based survey 360 may tow each streamer comprised in streamer the array 374 to a plurality of different depths as indicated in FIG. 1H such that seismic data may be acquired and processed in a manner that avoids the effects of destructive interference due to sea-surface ghost waves. For instance, marine-based survey 360 of FIG. 1H illustrates eight streamers towed by vessel 380 at eight different depths. The depth of each streamer may be controlled and maintained using the birds disposed on each streamer.

Attention is now directed to methods, techniques, and workflows for processing and/or transforming collected data that are in accordance with some embodiments of this disclosure. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept may be applicable to the procedures, methods, techniques, and workflows as discussed herein. This iterative refinement can include use of feedback loops executed on an algorithmic basis, such as at a computing device (e.g., computing system 100 of FIG. 1A), and/or through manual control mechanisms based on user determinations or user inputs regarding whether a given step, action, template, or model has become sufficiently accurate.

Workflows for gas (e.g., CO₂, CH₄, etc.) storage capacity are disclosed. In various embodiments, these workflows determine storage capacity within depleted oil and/or gas reservoirs to meet emissions management objectives, though the techniques may be used for other types of Areas of Interest (“AOI”) associated with a resource site that may be suitable for storage and capacity determinations consistent with embodiments of these techniques. The workflows are based on a methodology where predictive forward stratigraphic models are used for creating simulation scenarios on rock densities by generating outputs on lithological distributions.

To perform capacity determinations of AOIs more efficiently, the presently disclosed embodiments employ forward stratigraphic models that use principles of mass and energy conservation to make gas storage predictions or estimations for the AOIs in question. These predictions according to one embodiment can include, but are not limited to, associated with lithological distributions generated using geological process modeling to create the stratigraphic model of the AOI. Furthermore, a computing system may apply forward stratigraphic modeling techniques to a sample sediment information and/or other suitable data to generate a geological process model or a predictive forward stratigraphic model related to properties of the sediment across an AOI in question. As such, in some embodiments, the geological process model may include predicted information regarding rock layers and sediment data comprised in a given AOI based on geological information captured at a resource site. Geological information may include rock porosity data, rock erosion data, rock strength data, rock age data, rock density data, rock corrosiveness data, salt content data, water current data, and the like which may be generated by sensor data based on lithological distributions associated with aforementioned data.

In some embodiments, a Geological Process Modeling simulator (GPM) may be used to work on physical simulations of sediment data (e.g., simulations for predicting the distribution of sediments though physical processes within a subsurface of a resource site). The physical processes within the subsurface of the resource site may be represented by geological models used to represent these processes in the form of mathematical models which are then translated into software predictions/estimations in the GPM. In one embodiment, the GPM may receive as input or be parameterized using several geological variables including geological time data for oil and gas reservoirs for which predictions are needed, associated sea level curve data in the chronological time, coefficient data needed to control an amount of sediments associated with the subsurface gas storage area of interest at the resource site, conditioning map data needed to control the spatial distribution of sediments associated with said gas storage area of interest at the resource site.

Once the variables are suitable (e.g., variables that stabilize the geological(s)), a GPM simulation may be executed or otherwise run to make predictive sequences as forward modeling. In some embodiments, geostatistical workflows may be used to generate sediment distributing data. In addition, the estimations for density and porosity associated with the potential subsurface gas storage area at the resource site, for example, may be captured using sensors that capture, for example, wellbore measurements, direct core testing measurements, etc. In some embodiments, however, data from these past techniques may also be incorporated into GPM simulation runs.

In one embodiment, a workflow is presented where density and porosity estimations associated with the potential subsurface gas storage area at the resource site, are generated using a forward stratigraphic model based on integration of physical processes of deposition data (e.g., diffusion, steady flow, unsteady flows, carbonate deposition through wave actions, In situ, sediment growth, suspended sediment, etc., associated with said potential subsurface gas storage area. The In situ sediment deposition may refer specifically to carbonate sediments information developed and grown within the depositional basin of interest depending upon the physical and chemical conditions within the surface or subsurface environment at a given paleogeological time. In some cases, suspended sediment load data reflecting deposition of sediment into available accommodation spaces within the subsurface of the resource site may be determined. The sediment load deposition data may indicate a basin of interest at the resource site for a given depositional system in the subsurface where a process of heavier sediments subtly falling out of suspension and water depths over a period of geological time into said accommodation spaces within the subsurface. In some embodiments, the steady flow and other physical processes in the subsurface of the resource site relate to the sediments which constitute a reservoir framework at the resource site. These sediments may include sands, shales, shaly sands, silts, and carbonates. In one embodiment, the steady flow may be a physical process, however, which can be used to model lava flows, and hence volcanic deposit data within the subsurface. In some instances, volcanic deposit data altered lately by a number of geological processes of weathering etc., for example, of fractured granite can also be used to inject gas (e.g., CO₂). In other instances, such as fractured granites that produced oil and gas, it is the fractures themselves which hold the hydrocarbon in place, not the pores. Hence GPM prediction/estimation would not be used to predict fracture modeling in these rock types associated with the subsurface at the resource site; nevertheless, other tools, such as SLB's Petrel software, may be used to interpret and model fractures in such cases as an addition to the GPM simulation.

A stratigraphic forward model may provide input for making predictions for the physical densities of the sediments as the simulator (e.g., a forward stratigraphic simulator) may be based on an availability of a large number of sediment densities values; and GPM can model sedimentary transport, such as diffusion where sediments are eroded and transported downslope. In one embodiment, gas storage calculations/estimations according to some aspects of this disclosure is carried out by using, for example, a forward model to predict sediments, and then using a forward stratigraphic simulator to predict and obtain density (physical density of sediments) and porosity estimations along with bulk and net/gross storage. GPM Simulation on Lithological Densities. The Geological Process Modeling (GPM) may help generate predictive simulation data over a chronological time for geological depositional environments. Hence, information can be obtained from oil and gas reservoirs together with associated rock properties which constitute said reservoirs. Since the GPM tool predictions are based on the integration of physical densities of the simulated rock units, the critical piece of information from these predictions i.e., physical densities of the rock units, is obtained.

GPM Reservoir Porosity Predictions. The Geological Process Modeling (GPM) tool also enables determinations of the porosity estimations by offering a simple load method for calculating porosities of the above mentioned predictive lithologies and or sediments.

Now with density and porosity, one can also determine the Bulk Volume and Net/Gross for such reservoirs by converting GPM model simulations into geological grids, hence adding other key inputs for calculating gas storage i.e., Bulk Volume and Net/Gross.

An equation used in various embodiments of the present disclosure is:

$$gas storage capacity ( kg ) = BV * N / G * E * porosity * density of gas$$

where
BV=Bulk Volume of the Reservoir (obtained through Forward Model)
N/G=Net/Gross obtained by the porosity estimations from predicted forward model (obtained through forward model)
E=Efficiency Factor which, in some embodiments, is set to a value of 2 for the gas (e.g., CO₂)
Porosity=Obtained from the predicted forward model through simple load (obtained through forward model)
Density of gas=which can be calculated for a specific reservoir depth

Here, for example, the bulk volume refers in this process to the total pore volume which is available within the depleted Oil and Gas Reservoir which can be representing an assemblage of several sediments which include, sand, shales, shaly sands etc. The Net/Gross value will determine the available storage in terms of the effective pore volume which is available to ingest gases such as CO₂ and CH₄ as total pore volumes which are referred as the Bulk Volume are without taking into account the factor of connectivity and permeability and taking out shalier fractions which are normally having high total porosities but zero to non-existing effective porosity, which is used for calculating the storage capacity.

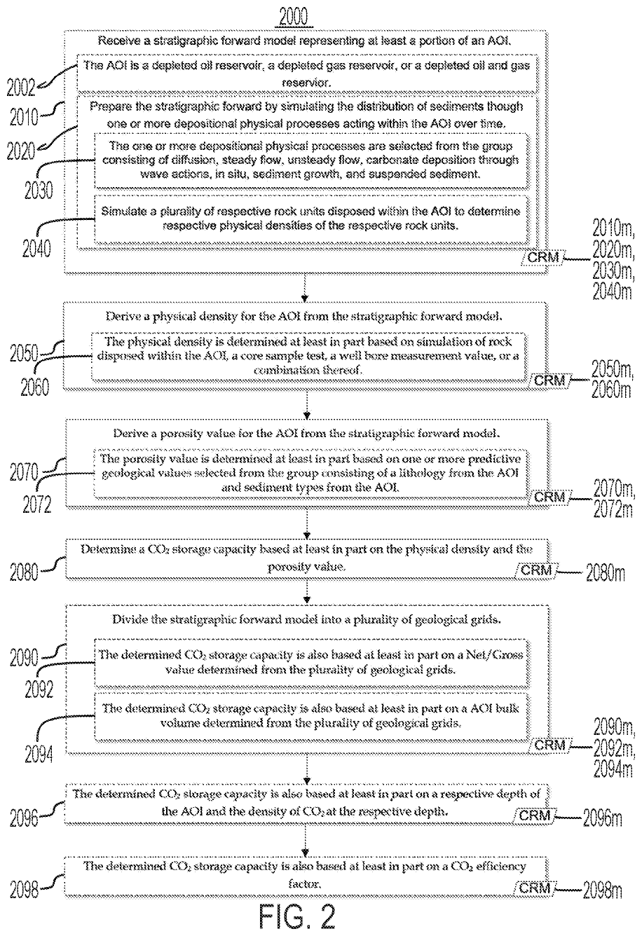

It is important to highlight that this workflow is based on modelling predictions (e.g., forward modelling predictions), and it may also be calibrated and conditioned to pre-existing data regarding a depleted reservoir or AOI being reviewed. Attention is now directed to method 2000 (FIG. 2), which may be carried out on a computing system, e.g., 100 in FIG. 1A, to determine a gas storage capacity of an AOI, e.g., reservoirs 304 in FIG. 1G (see also FIG. 2, block 2002 where the AOI is a depleted oil, gas, or oil, and gas reservoir).

FIG. 2 shows an exemplary method for determining the gas storage capacity of an AOI for a gas (e.g., CO₂). In particular, the method 2000 begins with receiving 2010 a stratigraphic model (e.g., a stratigraphic forward model) representing at least a portion of the AOI. In some embodiments, the method includes preparing the stratigraphic model by simulating the distribution of sediments though one or more depositional physical processes acting within the AOI over time (e.g., FIG. 2 at block 2020). It is appreciated that the one or more depositional physical processes may be selected from the group consisting of diffusion data, steady flow data, unsteady flow data, carbonate deposition data through wave actions, in situ, sediment growth data, and suspended sediment data (e.g., FIG. 2 at block 2030). According to one embodiment, the simulation includes simulating a plurality of rock units disposed within the AOI to determine respective physical densities of the rock units (e.g. FIG. 2 at block 2040).

The method 2000 continues with deriving, at block 2050, a physical density for the AOI from the stratigraphic model (e.g., stratigraphic forward model). In some embodiments, the physical density is determined at least in part based on simulation of rock disposed within the AOI, a core sample test, a well bore measurement value, or a combination thereof (e.g., FIG. 2 at block 2060).

The method 2000 continues with deriving, at block 2070, a porosity value for the AOI from the stratigraphic model (e.g., stratigraphic forward model). In some embodiments, the porosity value is determined at least in part based one or more predictive geological values selected from the group consisting of a lithology from the AOI and sediment types from the AOI (e.g., FIG. 2 at block 2070).

The method 2000 continues with determining, at block 2080, the gas (e.g., CO2) storage capacity based at least in part on the physical density and the porosity value. In some embodiments, the stratigraphic model (e.g., forward stratigraphic model) is divided into a plurality of geological grids (e.g., FIG. 2 at block 2090), which can then be used to determine a net/gross value (e.g., FIG. 2 at block 2092), and/or a AOI bulk volume (e.g., FIG. 2 at block 2094). In additional embodiments, the determined gas (e.g., CO₂) storage capacity may be based at least in part on a respective depth of the AOI and the density of the gas (e.g., CO₂) at that depth (e.g., FIG. 2 at block 2096) and in further embodiments, a gas (e.g., CO₂) efficiency factor may be used to determine the gas (e.g., CO₂) storage capacity (e.g., FIG. 2 at block 2098). It is appreciated that the letter “m” in 2010 m, 2020 m, 2030 m, etc. indicate blocks with associated sub-blocks within FIG. 2.

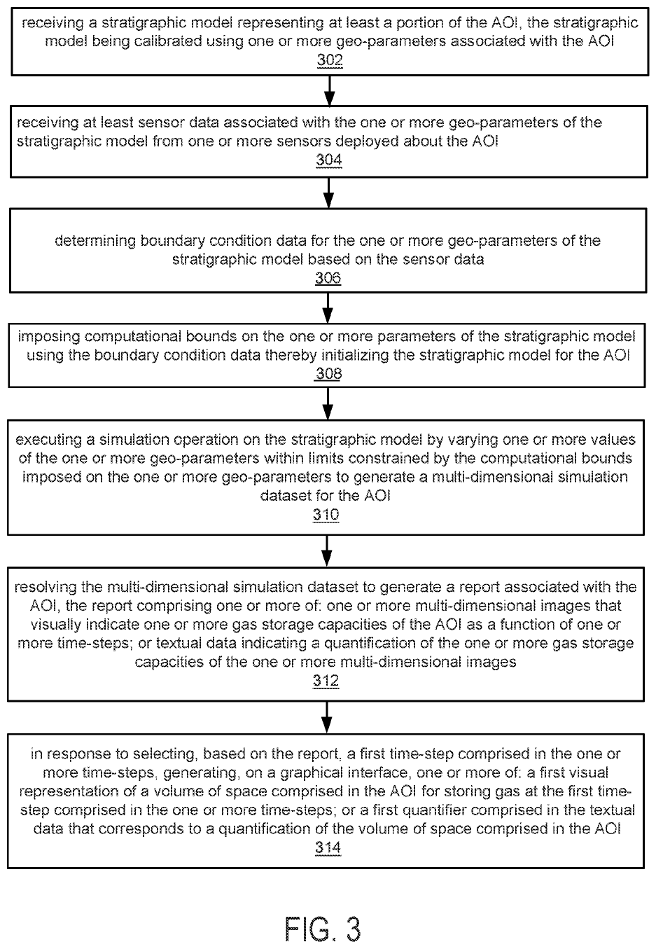

FIG. 3 shows an exemplary flowchart associated with methods, systems, and computer programs for determining gas storage capacity in a subsurface area of interest (“AOI”) at a resource site. It is appreciated that a data manager or a data processing engine or a signal processing engine stored in a memory device may cause a computer processor to execute the various processing stages of FIG. 3. At block 302, the data manager may receive a stratigraphic model representing at least a portion of the AOI. The stratigraphic model may be calibrated using one or more geo-parameters associated with the AOI. Continuing to block 304 of FIG. 3, data manager may receive at least sensor data associated with the one or more geo-parameters of the stratigraphic model from or derived from one or more sensors deployed about the AOI. In some embodiments, the sensor data is synthetic sensor data derived from previous simulations or test data. At block 306, the data manager may determine boundary condition data for the one or more geo-parameters of the stratigraphic model based on the sensor data. The data manager may further impose, at block 308, computational bounds on the one or more geo-parameters of the stratigraphic model using the boundary condition data thereby initializing the stratigraphic model for the AOI. At block 310, the data manager may execute a simulation operation on the stratigraphic model by varying one or more values of the one or more geo-parameters within limits constrained by the computational bounds imposed on the one or more geo-parameters to generate a multi-dimensional simulation dataset for the AOI. The data manager may further resolve, at block 312, the multi-dimensional simulation dataset to generate a report associated with the AOI. The report may comprise, for example, one or more of: one or more multi-dimensional images that visually indicate one or more gas storage capacities of the AOI as a function of one or more time-steps; or textual data indicating a quantification of the one or more gas storage capacities of the one or more multi-dimensional images. In response to selecting, based on the report, a first time-step comprised in the one or more time-steps, the data manager may generate on a graphical interface, at block 314, one or more of: a first visual representation of a volume of space comprised in the AOI for storing gas at the first time-step comprised in the one or more time-steps; or a first quantifier comprised in the textual data that corresponds to a quantification of the volume of space comprised in the AOI. It is appreciated that once the one or more gas storage capacities are determined, operations associated with injecting or storing the gas in question within the AOI based the determined gas storage capacities may be initiated.

These and other implementations may each optionally include one or more of the following features. The geo-parameters (e.g., referenced in association with FIG. 3) of the stratigraphic model comprise one or more of: porosity data associated with the AOI; lithographic data associated with the AOI; depth of sediment deposition data associated with the AOI; sea level variation data associated with the AOI; sediment compaction data associated with the AOI; and sediment density data associated with the AOI.

Moreover, the one or more multi-dimensional images comprise one of: a plurality of 2-dimensional image data corresponding to a plurality of gas storage volumes of the AOI based on the one or more time-steps; and a plurality of 3-dimensional image data corresponding to a plurality of gas storage volumes of the AOI based on the one or more time-steps. According to some embodiments, the gas discussed in association with FIG. 3 comprises one of carbon dioxide (CO₂), methane (CH₄), nitrous oxide (N₂O), or a fluorinated gas. In addition, the AOI comprises one of a depleted oil reservoir, a depleted gas reservoir, or a depleted oil and gas reservoir.

According to some embodiments, at least one geo-parameter comprised in the one or more geo-parameters is determined based on one or more of: the sensor data associated with the one or more geo-parameters, the sensor data comprising actual data measurements by one or more surface or subsurface sensors deployed at the resource site; or synthetic data comprising one or more of: simulation data associated with simulating rock properties comprised in the AOI, and analysis data associated with extracting and analyzing or testing a geological core sample associated with the AOI. Furthermore, the one or more geo-parameters may comprise porosity data associated with the AOI such that the porosity data is determined based on one or more predictive porosity values generated based executing a plurality of simulations on the stratigraphic model over: a first period of time; or a second period of time; or a combination of the first period of time and the second period of time. Moreover, the plurality of simulations determine or predict, gas storage volume mutation data associated with the AOI and which indicates size and seal effects of a volume of space comprised in the AOI within which gas is stored over one of: the first period of time; the second period of time; or the combination of the first period of time and the second period of time. In addition, the plurality of simulations may be used to optimize the boundary condition data.

According to some embodiments, the flowchart of FIG. 3 further comprises dividing the stratigraphic model into a plurality of geological grids such that each grid comprised in the plurality of geological grids corresponds to a micro-volume associated with the AOI within which gas is stored. Additionally, the plurality of geological grids can enable resolving the AOI into a plurality of micro-volumes which, in aggregate, determine a storage dimension for the AOI. It is appreciated that the one or more gas storage capacities are based on Net/Gross volume values determined from the plurality of geological grids. It is further appreciated that the one or more gas storage capacities are based on an AOI bulk volume determined from the plurality of geological grids. Moreover, the one or more gas storage capacities are based on one or more of: a respective depth of the AOI; and a gas density of a gas stored at the respective depth. It is further appreciated that the determined gas storage capacity is based on a gas efficiency factor indicating a fraction of total pore space associated with the AOI available for storage of a gas based on one or more of: heterogeneity data associated with the gas; buoyancy effect data associated with the gas; and residual water saturation data associated with storing the gas.

In some implementations, the stratigraphic model comprises a stratigraphic forward model generated by executing a plurality of simulation operations that test distribution (e.g., geological distribution) data relative to one or more depositional physical processes acting within the AOI over time. The one or more depositional physical processes may be selected from a group consisting of diffusion, steady flow, unsteady flow, carbonate deposition through wave actions, in situ, sediment growth, and suspended sediment. The plurality of simulation operations, for example, may include simulating a plurality of rock units disposed within the AOI to determine respective physical densities of the rock units.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection this disclosure.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit this disclosure to the precise forms disclosed. Many modifications and variations are possible in view of the above teachings. The embodiments were chosen and described in order to explain the principles of the disclosed subject-matter and its practical applications, to thereby enable others skilled in the art to utilize the disclosed techniques and various embodiments with various modifications as are suited to the particular use contemplated.

What is claimed is:

1. A method for determining gas storage capacity in a subsurface area of interest (“AOI”), the method comprising:
receiving, using a computer processor, a stratigraphic model representing at least a portion of the AOI, the stratigraphic model being calibrated using one or more geo-parameters associated with the AOI;
receiving, using the computer processor, at least sensor data associated with the one or more geo-parameters of the stratigraphic model from one or more sensors deployed about the AOI;
determining, using the computer processor, boundary condition data for the one or more geo-parameters of the stratigraphic model based on the sensor data;
imposing, using the computer processor, computational bounds on the one or more geo-parameters of the stratigraphic model using the boundary condition data thereby initializing the stratigraphic model for the AOI;
executing, using the computing processor, a simulation operation on the stratigraphic model by varying one or more values of the one or more geo-parameters within limits constrained by the computational bounds imposed on the one or more geo-parameters to generate a multi-dimensional simulation dataset for the AOI;
resolving, using the computer processor, the multi-dimensional simulation dataset to generate a report associated with the AOI, the report comprising one or more of:
one or more multi-dimensional images that visually indicate one or more gas storage capacities of the AOI as a function of one or more time-steps, or
textual data indicating a quantification of the one or more gas storage capacities of the one or more multi-dimensional images; and
in response to selecting, using the computer processor and based on the report, a first time-step comprised in the one or more time-steps, generating, on a graphical interface, one or more of:
a first visual representation of a volume of space comprised in the AOI for storing gas at the first time-step comprised in the one or more time-steps, or
a first quantifier comprised in the textual data that corresponds to a quantification of the volume of space comprised in the AOI.

2. The method of claim 1, wherein the one or more geo-parameters of the stratigraphic model comprise one or more of:
porosity data associated with the AOI;
lithographic data associated with the AOI;
depth of sediment deposition data associated with the AOI;
sea level variation data associated with the AOI;
sediment compaction data associated with the AOI; and
sediment density data associated with the AOI.

3. The method of claim 1, wherein the one or more multi-dimensional images comprise one of:
a plurality of 2-dimensional image data corresponding to a plurality of gas storage volumes of the AOI based on the one or more time-steps; and
a plurality of 3-dimensional image data corresponding to a plurality of gas storage volumes of the AOI based on the one or more time-steps.

4. The method of claim 1, wherein the gas comprises one of carbon dioxide (CO₂), methane (CH₄), nitrous oxide (N₂O), or a fluorinated gas.

5. The method of claim 1, wherein the AOI comprises one of a depleted oil reservoir, a depleted gas reservoir, or a depleted oil and gas reservoir.

6. The method of claim 1, wherein at least one geo-parameter comprised in the one or more geo-parameters is determined based on one or more of:
the sensor data associated with the one or more geo-parameters, the sensor data comprising actual data measurements by one or more surface or subsurface sensors deployed at a resource site; or
synthetic data comprising one or more of:
simulation data associated with simulating rock properties comprised in the AOI, and
analysis data associated with extracting and analyzing or testing a geological core sample associated with the AOI,

7. The method of claim 1, wherein the one or more geo-parameters comprise porosity data associated with the AOI, the porosity data being determined based on one or more predictive porosity values generated based executing a plurality of simulations on the stratigraphic model over a first period of time, or a second period of time or a combination of the first period of time and the second period of time.

8. The method of claim 7, wherein the plurality of simulations determine or predict, gas storage volume mutation data associated with the AOI and which indicates size and seal effects of a volume of space comprised in the AOI within which gas is stored over one of:
the first period of time;
the second period of time;
or the combination of the first period of time and the second period of time.

9. The method of claim 7, wherein the plurality of simulations is used to optimize the boundary condition data.

10. The method of claim 1, further comprising dividing the stratigraphic model into a plurality of geological grids, each grid comprised in the plurality of geological grids corresponding to a micro-volume associated with the AOI within which gas is stored.

11. The method of claim 10, wherein the plurality of geological grids enables resolving the AOI into a plurality of micro-volumes which, in aggregate, determine a storage dimension for the AOI.

12. The method of claim 10, wherein the one or more gas storage capacities are based on Net/Gross volume values determined from the plurality of geological grids.

13. The method of claim 10, wherein the one or more gas storage capacities are based on an AOI bulk volume determined from the plurality of geological grids.

14. The method of claim 1, wherein the one or more gas storage capacities are based on one or more of:
a respective depth of the AOI; and
a gas density of a gas stored at the respective depth.

15. The method of claim 1, wherein the one or more gas storage capacities are based on a gas efficiency factor indicating a fraction of total pore space associated with the AOI available for storage of a gas based on one or more of:
heterogeneity data associated with the gas;
buoyancy effect data associated with the gas; and
residual water saturation data associated with storing the gas.

16. The method of claim 1, wherein the stratigraphic model comprises a stratigraphic forward model generated by executing a plurality of simulation operations that test distribution data relative to a plurality of one or more depositional physical processes acting within the AOI over time.

17. The method of claim 16, wherein the one or more depositional physical processes are selected from the group consisting of diffusion, steady flow, unsteady flow, carbonate deposition through wave actions, in situ, sediment growth, and suspended sediment.

18. The method of claim 16, wherein the plurality of simulation operations include simulating a plurality of rock units disposed within the AOI to determine respective physical densities of the rock units.

19. A computer program for determining gas storage capacity in a subsurface area of interest (“AOI”), the computer program comprising a non-transitory computer-readable medium comprising code configured to:
receive a stratigraphic forward model representing at least a portion of the AOI, the stratigraphic model being calibrated using one or more geo-parameters associated with the AOI;
receive at least sensor data associated with the one or more geo-parameters of the stratigraphic model from one or more sensors deployed about the AOI;
determine boundary condition data for the one or more geo-parameters of the stratigraphic model based on the sensor data;
impose computational bounds on the one or more geo-parameters of the stratigraphic model using the boundary condition data thereby initializing the stratigraphic model for the AOI;
execute a simulation operation on the stratigraphic model by varying one or more values of the one or more geo-parameters within limits constrained by the computational bounds imposed on the one or more geo-parameters to generate a multi-dimensional simulation dataset for the AOI;
resolve the multi-dimensional simulation dataset to generate a report associated with the AOI, the report comprising one or more of:
one or more multi-dimensional images that visually indicate one or more gas storage capacities of the AOI as a function of one or more time-steps, or
textual data indicating a quantification of the one or more gas storage capacities of the one or more multi-dimensional images;
in response to selecting, using the computer processor and based on the report, a first time-step comprised in the one or more time-steps, generating, on a graphical interface, one or more of:
a first visual representation of a volume of space comprised in the AOI for storing gas at the first time-step comprised in the one or more time-steps, or
a first quantifier comprised in the textual data that corresponds to a quantification of the volume of space comprised in the AOI.

20. A system for determining gas storage capacity in a subsurface area of interest (“AOI”), the system comprising:
a computer processor, and
memory storing a data processing engine that comprises instructions which are executable by the computer processor to:
receive a stratigraphic forward model representing at least a portion of the AOI, the stratigraphic model being calibrated using one or more geo-parameters associated with the AOI;
receive at least sensor data associated with the one or more geo-parameters of the stratigraphic model from one or more sensors deployed about the AOI;
determine boundary condition data for the one or more geo-parameters of the stratigraphic model based on the sensor data;
impose computational bounds on the one or more geo-parameters of the stratigraphic model using the boundary condition data thereby initializing the stratigraphic model for the AOI;
execute a simulation operation on the stratigraphic model by varying one or more values of the one or more geo-parameters within limits constrained by the computational bounds imposed on the one or more geo-parameters to generate a multi-dimensional simulation dataset for the AOI;
resolve the multi-dimensional simulation dataset to generate a report associated with the AOI, the report comprising one or more of:
one or more multi-dimensional images that visually indicate one or more gas storage capacities of the AOI as a function of one or more time-steps, or
textual data indicating a quantification of the one or more gas storage capacities of the one or more multi-dimensional images;
in response to selecting, using the computer processor and based on the report, a first time-step comprised in the one or more time-steps, generating, on a graphical interface, one or more of:
a first visual representation of a volume of space comprised in the AOI for storing gas at the first time-step comprised in the one or more time-steps, or
a first quantifier comprised in the textual data that corresponds to a quantification of the volume of space comprised in the AOI.
